(19) United States
(12) Patent Application Publication
(10) Pub. No.: US 2006/0038790 A1
(43) Pub. Date: Feb. 23, 2006

(54) Touch panel

(75) Inventors: Chien-Chung Chen, Taichung City (TW); Kuan-Lin Chen, Changhua County (TW); Chin-Pei Hwang, Taichung City (TW)

Correspondence Address: BACON & THOMAS, PLLC, 625 SLATERS LANE, FOURTH FLOOR, ALEXANDRIA, VA, 22314, US

(73) Assignee: Wintek Corporation, TAICHUNG (TW)

(21) Appl. No.: 10/919,329

(22) Filed: Aug. 17, 2004

(51) Int. Cl. G09G 5/00

(52) U.S. Cl. 345/173

(57) ABSTRACT

A touch panel has a substrate, a non-oxide adhesive layer and an indium tin oxide (ITO) film. The non-oxide adhesive layer is attached on the substrate and the ITO film is attached on the non-oxide adhesive layer. The non-oxide adhesive layer will not diffuse oxygen in the high temperature environment to affect the indium tin oxide film, so that the panel keeps in a thermal stable condition.

### BACKGROUND OF THE INVENTION

1. Field of the Invention

The present invention relates generally to an electronic device, and more particularly to a touch panel, which the conductive film is thermal stabilization.

2. Description of the Related Art

In a touch panel, the indium tin oxide (ITO) film is the most import element that affects the quality of the product. It is very important to keep the ITO film in a stable condition under heat.

The conventional tough panel provides the ITO film laminated on a plastic substrate by a silicon oxide (SiO₂) adhesive film. It is because that there is a huge difference between the lattice constants of the substrate and the ITO film. The panel takes many processes, such as the annealing and the reliability testing, in the process of fabrication. The oxygen of the SiO₂ film is diffused into the ITO film in the process under a high temperature for a long time. It losses thermal stabilization of the ITO film, in the other words, it affects the quality of the ITO film.

In addition, there is a roll-to-roll web coating machine applied in the process of fabrication. The gas in the chambers of the machine is diffused because the chambers are not well isolated from each other. The gas affects the quality of the ITO film, which is sensitive to oxygen, too.

### SUMMARY OF THE INVENTION

The primary objective of the present invention is to provide a touch panel, which provides a non-oxide material to replace the SiO₂ film for adhesion layer of the ITO film on the substrate, such that the ITO film is not affected by oxygen.

According to the objectives of the present invention, a touch panel comprises a substrate. A non-oxide adhesive layer is attached on the substrate. An indium tin oxide film is attached on the non-oxide adhesive layer. The non-oxide adhesive layer will not diffuse oxygen in the high temperature environment to affect the indium tin oxide film, so that the panel keeps in a stable condition.

### BRIEF DESCRIPTION OF THE DRAWINGS

FIG. 1 is a sectional view of a first preferred embodiment of the present invention, and FIG. 2 is a sectional view of a second preferred embodiment of the present invention.

### DETAILED DESCRIPTION OF THE INVENTION

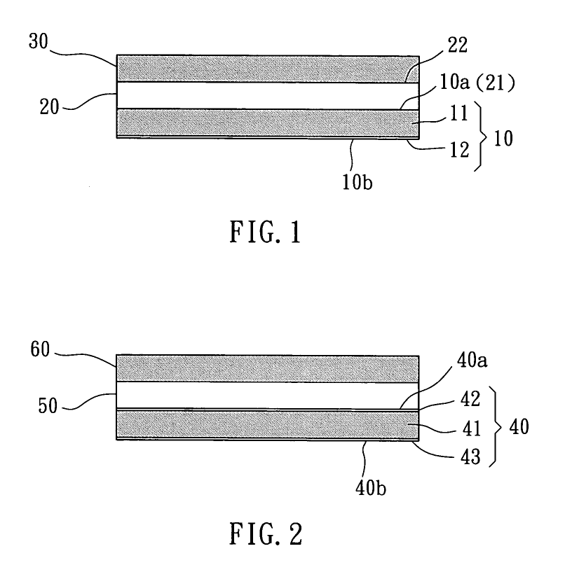

As shown in FIG. 1, a touch panel of the first preferred embodiment of the present invention comprises a substrate 10, a non-oxide adhesive layer 20 and an indium tin oxide (ITO) film 30.

The substrate 10 has a plastic main member 11 and a hard coating layer 12 on a side of the main member 11. The substrate 10 defines a top side 11a at the side without the hard coating layer 12 and a bottom side 11b at the side with the hard coating layer 12. In the first preferred embodiment, the main member 10 is made of polyethylene terephthalate (PET) with a thickness between 100 μm and 200 μm. The hard coating layer 12 is made of acrylic organic resin with a thickness between 3 μm and 10 μm. In practice, the main member can be made of polyethersulfone (PES) or polycarbonate (PC) and the hard coating layer 12 can be made of a material of the mixture of organic resin and inorganic resin.

The non-oxide adhesive layer 20 is made of silicon nitride (Si₃N₄), which is made from introducing nitrogen to silicon-aluminum material for sputter and deposition. A thickness of the non-oxide adhesive layer 20 is between 10A and 1000A. The non-oxide adhesive layer 20 has a first side 21 and a second side 22, wherein the first side 21 of the non-oxide adhesive layer 20 is attached on the top side 10a of the substrate 10.

The ITO film 30 is laminated on the second side 22 of the non-oxide adhesive layer 20.

Table 1 is the data of the reliability test of touch panels having silicon oxide (SiO₂) and silicon nitride (Si₃N₄) to be the adhesive layer. The surface resistance of the panels are listed in Table 1.

TABLE 1

| | SiO₂ + ITO | Variation(R − R0) | Si₃N₄ + ITO | Variation(R − R0) |
|---|---|---|---|---|
| Initial resistance (R0) | 311.3 | | 269 | |
| Resistance after 120 hr (R) | 314.9 | 3.6 | 293.6 | −2.4 |
| Resistance after 288 hr (R) | 335.3 | 24.3 | 308.3 | 12.3 |
| Resistance after 336 hr (R) | 355.3 | 44 | 303 | 7 |
| Resistance after 426 hr (R) | 380.7 | 69.4 | 303.7 | 7.7 |
| Resistance after 560 hr (R) | 381 | 69.7 | 305.8 | 9.8 |
| Resistance after 752 hr (R) | 385.8 | 74.5 | 316.1 | 20.1 |
| Resistance after 920 hr (R) | 390.3 | 79 | 317 | 21 |

Table 1 shows the Si₃N₄ adhesive layer of the present invention provides less variation of the surface resistant than the conventional SiO₂ adhesive layer, which means the touch panel of the present invention is more stable.

In addition, the non-oxide adhesive layer can be made of a material chosen from titanium nitride (TiN), zirconium nitride (ZrN), silicon carbide (SiC), titanium carbide (TiC), aluminum nitride (AlN) or chromium nitride (CrN).

The present invention provides the non-oxide adhesive layer to be the interface bonding the ITO film on the substrate. There is no oxygen diffused to the ITO film in the high temperature environment, so that the ITO film is thermal stable and the surface resistance of the ITO film keeps stable. The quality of the touch panel, therefore, increases a lot.

As shown in FIG. 2, a touch panel of the second preferred embodiment of the present invention comprises a substrate 40, a non-oxide adhesive layer 50 and an ITO film 60 similar to the panel of the first preferred embodiment. The substrate 40 has two hard coating layers 42 and 43 on opposite sides thereof. The ITO film 60 is coating on the layer 42 of the substrate via the non-oxide adhesive layer 50.

The scope of the present invention is not restricted in the preferred embodiments only. Any equivalent structure should be in the claim of the present invention.

What is claimed is:

1. A touch panel, comprising:
a substrate having a top side and a bottom side;
a non-oxide adhesive layer having a fist side and a second side, wherein the first side of the non-oxide adhesive layer is attached on the top side of the substrate, and
an indium tin oxide film attached on the second side of the non-oxide adhesive layer.

2. The touch panel as defined in claim 1, wherein the substrate has a main member and a hard coating layer on a side of the main member and the non-oxide adhesive layer is attached on a side of the main member without the hard coating layer.

3. The touch panel as defined in claim 2, wherein the main member 10 is made of a material chosen from polyethylene terephthalate (PET), polyethersulfone (PES) or polycarbonate (PC) and a thickness thereof is beween 100 μm and 200 μm.

4. The touch panel as defined in claim 2, wherein the hard coating layer has a thickness between 3 μm and 10 μm.

5. The touch panel as defined in claim 1, wherein the substrate has a main member and two hard coating layers on opposite sides of the main member and the non-oxide adhesive layer is attached on the hard coating layer.

6. The touch panel as defined in claim 5, wherein the main member 10 is made of a material chosen from polyethylene terephthalate (PET), polyethersulfone (PES) or polycarbonate (PC) and a thickness thereof is beween 100 μm and 200 μm.

7. The touch panel as defined in claim 5, wherein the hard coating layer has a thickness between 3 μm and 10 μm.

8. The touch panel as defined in claim 1, wherein the non-oxide adhesive layer can be made of a material chosen from silicon nitride (Si₃N₄), titanium nitride (TiN), zirconium nitride (ZrN), silicon carbide (SiC), titanium carbide (TiC), aluminum nitride (AlN) or chromium nitride (CrN).
